(19) United States
(12) Patent Application Publication
(10) Pub. No.: US 2003/0078855 A1
(43) Pub. Date: Apr. 24, 2003

(54) System to pay and for information

(76) Inventor: Stephan Karlsten, Goteborg (SE)

Correspondence Address: Orum & Roth, 53 West Jackson Boulevard, Chicago, IL, 60604-3606, US

(21) Appl. No.: 10/239,351

(22) PCT Filed: Mar. 30, 2001
(86) PCT No.: PCT/SE01/00699

(30) Foreign Application Priority Data
Mar. 31, 2000 (SE) 0001185-8

(51) Int. Cl. G06F 17/60

(52) U.S. Cl. 705/26

(57) ABSTRACT

The invention relates to a system (1) for payment and information intended for the Internet or some other network, to which all the parties involved in the system are connected. A payment unit (2) functioning as a central unit is so arranged, in addition to functioning both as a recipient and as a payer of settlements in cash, as to function also as a recipient of information and a transmitter of information. The system (1) also has connected to it a number of sales organizations (8), logistics companies (9), suppliers (10) of goods (11) and customers (12), with an information link. The flow of information and payment is so arranged as to take place as follows: the customer (12) gives notification (A) of an order for goods (11) and pays (B) directly to the central unit (2), the central unit (2) informs (C) the parties (8-10) concerned of the order and pays (D) the supplier (10) for the goods (11), the goods (11) are delivered to the customer (12) by the logistics company (9), and payment is made by the central unit (2) to the parties (8; 9, 14) concerned, in conjunction with which payment (D, F) is so arranged as to take place electronically, and the payments (D, F) transmitted are released to the parties concerned when information to the effect that the goods (11) have left the supplier's (10) premises is transmitted.

The present invention relates to a system for payment and information intended for the Internet or some other network, to which all the parties involved in the system are connected.

Problems are associated with ensuring that all those who are involved in a producer and selling chain for goods reliably obtain payment for their services. Also, if delivery is not effected within a specific, promised period, there is a wish to be able to cancel orders so that an order can be placed with another producer instead.

Previously disclosed systems for commerce via the Internet or some other network, to which the various parties in the system are connected, do not permit sufficiently reliable payment and guaranteed delivery, since payment is often made directly to the sales organization and/or the producer of the goods from whom the goods are ordered.

In order to exclude the possibility of misusing previously disclosed systems, it is necessary to allow a neutral, external party to take care of the payment and information flow. To some degree, consideration has been given to the possibility of allowing an external party to receive money for goods that are ordered, although this has proved to be a complicated system which has not yet functioned reliably.

The principal object of the present invention is thus, in the first instance, to solve the aforementioned problems in a reliable and efficient fashion and without incurring major levels of cost.

The aforementioned object is achieved by means of a payment and information system in accordance with the present invention, which is characterized essentially in that a payment unit functioning as a central unit is so arranged, in addition to functioning both as a recipient and as a payer of settlements in cash, as to function also as a recipient of information and a transmitter of information, and in that the system also has connected to it a number of sales organizations, logistics companies, suppliers of goods and customers, with an information link, in conjunction with which the flow of information and payment is so arranged as to take place as follows:

the customer gives notification of an order for goods and pays directly to the central unit,

the central unit informs the parties concerned of the order and pays the supplier for the goods;

the goods are delivered to the customer by the logistics company, and payment is made by the central unit to the parties concerned, in conjunction with which payment is so arranged as to take place electronically, and the payments transmitted are released to the parties concerned when information to the effect that the goods have left the supplier's premises is transmitted.

The invention is described below as a preferred illustrative embodiment, in conjunction with which reference is made to the accompanying drawings, in which:

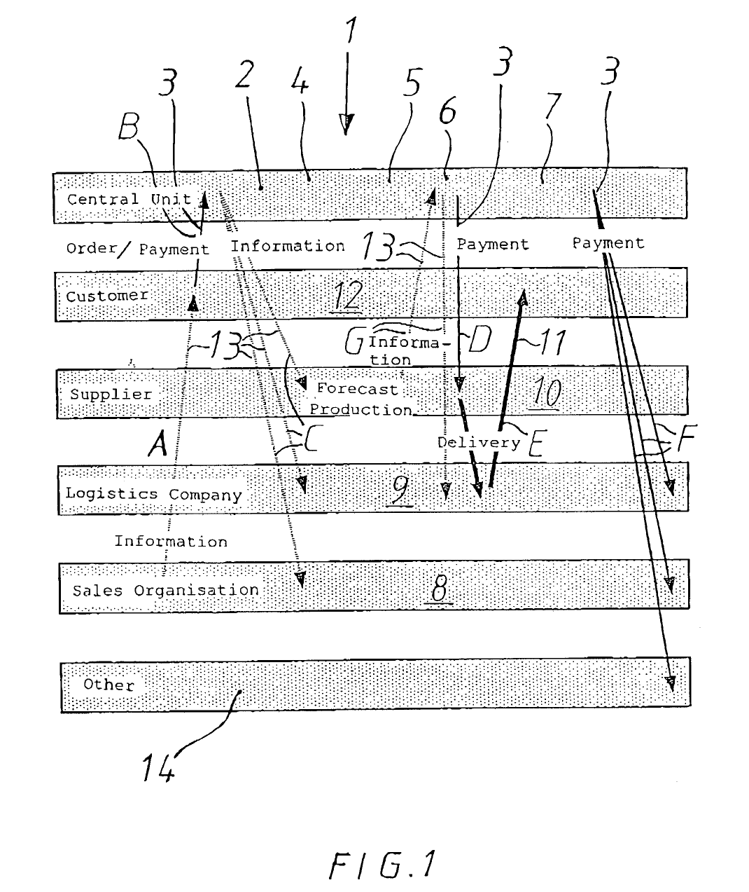

FIG. 1 shows the system schematically and with different sequences illustrated;

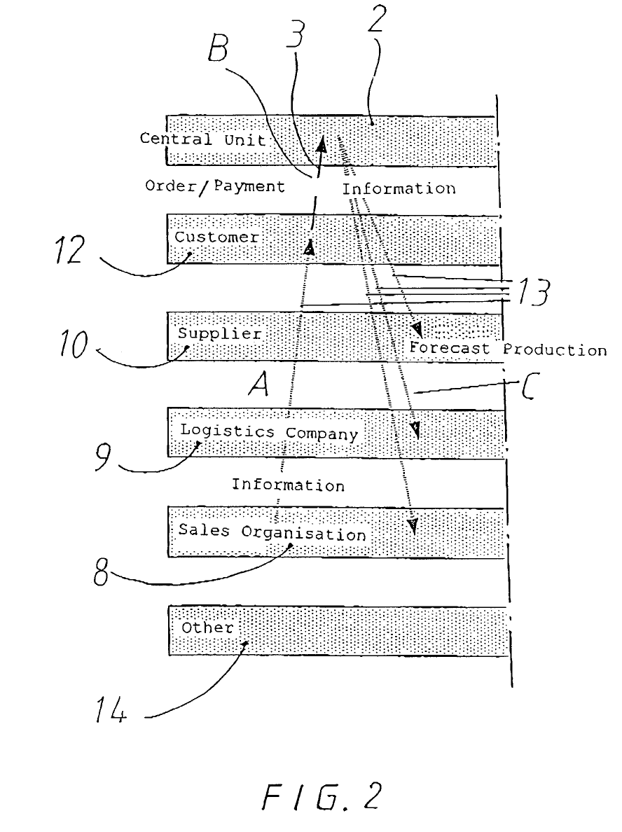

FIG. 2 shows a first phase of the application of the system, primarily the information flow;

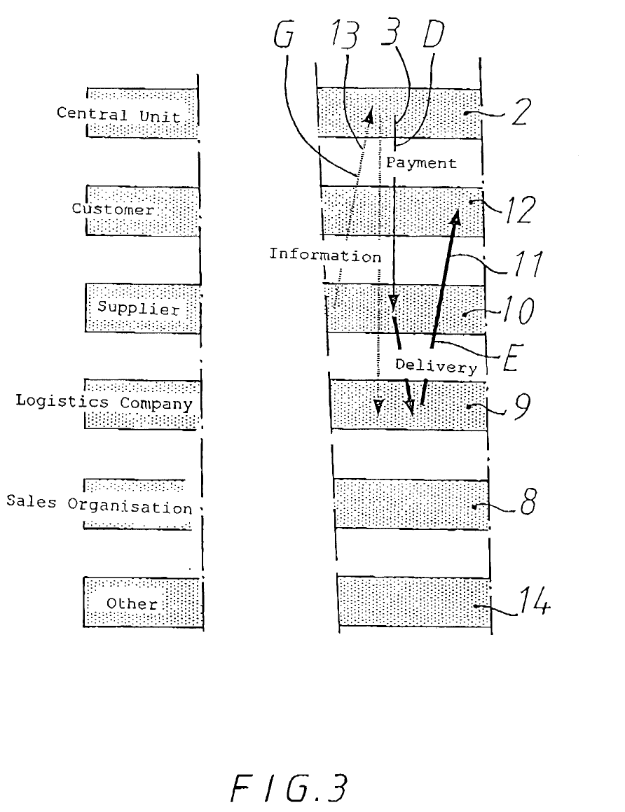

FIG. 3 shows the subsequent phase of the system, i.e. the transfer of information, payment and deliveries; and

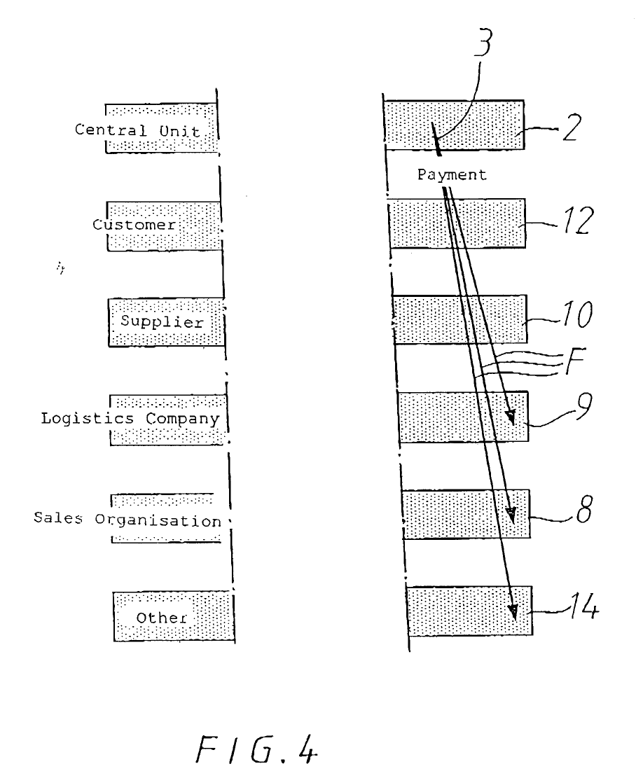

FIG. 4 shows a final phase of the system, in this case an example of a completed transaction, namely the remittance of payment to different parties.

A payment and information system 1 in accordance with the present invention, which is intended for the Internet or some other network, to which all the parties involved in the system have access and are connected, has at is core a payment unit 2 functioning as a central unit. This unit 2 is so arranged, in addition to functioning both as a recipient 4 and as a payer 5 of settlements in cash 3 or other instruments that are equivalent thereto, as to function also as a recipient 6 of information and a transmitter 7 of information.

Also linked into the system 1 is a number of sales organizations 8, logistics companies 9, suppliers 10 of the goods 11 in question that it is wished to sell and customers 12, all of whom have an information link 13 at least to the central unit 2.

The flow of information and payments in accordance with the present system 1 is thus so arranged as to take place as follows: the customer 12 gives notification A of an order for goods, and information to this effect is transmitted to the central unit 2, and the customer 12 pays B directly to the central unit 2.

The central unit 2 in turn informs C the parties 8-10 concerned of the order and pays D the supplier 10 for the goods before they are despatched.

The goods 11 are then delivered E to the customer 12 by the logistics company 9, and payment F for the services and goods provided is made by the central unit 2 to the parties 9, 8, 14 concerned. Payment D, F, is so arranged as to take place electronically, so that the payments transmitted are released to the parties concerned when information C to the effect that the goods 11 have left the supplier's premises is transmitted.

The information A, B in question, to the effect that an order has been placed, is so arranged as to be made available to the parties concerned via an on-line code system on the Internet, etc.

A bar code reader is so arranged as to be included in the system 1 at the premises of the supplier 10 who produces the goods 11 in question, in conjunction with which the aforementioned bar code reader may be connected to the system 1 so that, when bar code reading takes place, a signal is transmitted immediately to the central unit 2 for the remittance of payment F to the parties 8, 9, 14 concerned. Payments to the parties 8, 9, 14 concerned can be so arranged as to take place only at specific times, e.g. on a number of occasions each month.

The system 1 can also be so arranged, in the event of the customer 12 notifying the central unit 2 of his intention to cancel an agreement that has been entered into, that information to that effect is transmitted from the central unit 2 to the parties 8-10, 14 concerned, and that any money 3 is returned to the customer 12.

The system 1 also includes external recipients 14 of money 3 from the central unit 2. An example of this may be a royalty payment in respect of sales or a patent, for example.

The following are further details of the invention and the numerous possibilities and advantages which it offers, and as an explanation of the drawings it must also be pointed out that dotted arrows indicate the flow of information, thin arrows indicate the flow of cash, and heavy arrows indicate the flow of goods.

I. Full Security

Once the money has been paid in, only two things can happen:

a) The money is distributed by electronic means in accordance with a predetermined template once delivery is effected.

b) The money is repaid to the consumer if delivery is not effected.

II. Outsourcing

The company which operates this system is entirely independent, has the status of a bank/finance company and is liable at law for its actions, and is required to have insurance cover to protect its depositors.

III. Paperless Services

The system automatically creates accounting documents which the connected parties can download for themselves via the Internet, etc. These accounting documents satisfy the requirements of the local tax authorities.

IV. The System Connects the End Consumer to the Producer

a) The consumer is aware, at the time of placing the order on-line, of the time when delivery will be effected in accordance with the information about current production capacity programmed into the system.

b) The producer can plan his production on the basis of daily incoming orders. If the producers increase their capacity, this must be programmed into the system immediately.

V. Functional Description of the System

An order from an end consumer is entered via the Internet. Payment for the order is effected directly by electronic payment. The order is acknowledged once the money has been recorded as paid in the closed system.

VI. This order-specific information is accessible via an on-line code system to:

a) The producer/producers, i.e. the suppliers 10.

b) The logistics company/logistics companies.

c) The sales organization 8.

d) Other parties in the payments template.

a)-d) are all independent companies.

VII. The delivery date, i.e. the maximum delivery delay, is indicated on-line at the time of ordering.

VIII. The consumer, ie. the customer, can obtain a confirmation of order immediately via the Internet once the payment has been recorded.

IX. When the goods have been despatched from the producers, the system is notified via bar code reading performed by a person at the request of the responsible company. When bar code reading takes place, a signal is transmitted immediately to the effect that the producers will receive payment in accordance with a predetermined template. On receipt of this signal, the money in the system is released to the parties concerned.

X. The logistics companies have continuous access at all times to information relating to deliveries from the producer to the customer, and they are able to plan accordingly.

XI. Payments to the logistics companies, sales organizations and other parties are made on a number of occasions each month in accordance with a predetermined distribution template, which has been accepted by all the parties/companies concerned.

XII. In the event of delivery not being effected as agreed, the consumer can cancel his order and will have his money refunded immediately.

The invention is naturally not restricted to the embodiment described above and illustrated in the accompanying drawings. Modifications are possible, especially in relation to the nature of the different parts or by the application of equivalent technology, without departing from the area of protection afforded to the invention as defined in the Patent claims.

1. System (1) for payment and information intended for the Internet or some other network, to which all the parties involved in the system are connected, characterized in that a payment unit (2) functioning as a central unit is so arranged, in addition to functioning both as a recipient and as a payer of settlements in cash, as to function also as a recipient of information and a transmitter of information, in that the information (A, B) in question is so arranged as to be made available to the parties concerned via an on-line code system on the Internet, etc, in that the system (1) also has connected to it a number of sales organizations (8), logistics companies (9), suppliers (10) of goods (11) and customers (12), with an information link, in conjunction with which the flow of information and payment is so arranged as to take place as follows:
the customer (12) gives notification (A) of an order for goods (11) and pays (B) directly to the central unit (2),
the central unit (2) informs (C) the parties (8-10) concerned of the order and pays (D) the supplier (10) for the goods (11),
the goods (11) are delivered to the customer (12) by the logistics company (9), and payment is made by the central unit (2) to the parties (8; 9, 14) concerned, in conjunction with which payment (D, F) is so arranged as to take place electronically, and the payments (D, F) transmitted are released to the parties concerned when information to the effect that the goods have left the supplier's (10) premises is transmitted, in that a bar code reader is included in the system (1) at the premises of the supplier (10) who produces the goods (11) in question, and that the aforementioned bar code reader is connected to the system (1) so that, when bar code reading takes place, a signal is transmitted immediately to the central unit (2) for the remittance of payment (F) to the parties (8, 9, 14) concerned.

2. System in accordance with patent claim 1, characterized in that payments to the parties (8, 9, 14) concerned are so arranged as to take place at certain specific times, e.g. on a number of occasions each month.

3. System in accordance with one or other of the above patent claims, characterized in that the system (1) is so arranged, in the event of customers (12) notifying the central unit (2) of their intention to cancel agreements that have been entered into, that information to that effect is transmitted from the central unit (2) to the parties (8-10, 14) concerned, and that any money (3) is returned to the customer (12).

4. System in accordance with one or other of the above patent claims, characterized in that the system (1) also includes external recipients (14) of money (3) from the central unit (2), such as a sales royalty or a patent royalty.
